(19) United States
(12) Patent Application Publication
(10) Pub. No.: US 2012/0206332 A1
(43) Pub. Date: Aug. 16, 2012

(54) METHOD AND APPARATUS FOR ORIENTATION SENSITIVE BUTTON ASSIGNMENT

(75) Inventor: Andrew Yonemoto, San Jose, CA (US)

(73) Assignee: Sony Corporation, Tokyo (JP)

(21) Appl. No.: 13/028,786

(22) Filed: Feb. 16, 2011

(51) Int. Cl. G09G 5/00

(52) U.S. Cl. 345/156

(57) ABSTRACT

Methods and apparatus are provided for orientation sensitive configuration of a device. In one embodiment a method includes detecting a change in orientation of a device, and configuring a display of the device based on the change in orientation. The method may further include assigning operation of one or more buttons of the device based on the change in orientation, wherein a button of the device is assigned one or more functions not previously assigned to the button. The method may be performed by one or more of portable electronic device, media player, eReader, personal communication device, handheld computing device, imaging device, tablet computing device, imaging device, gaming device and computing devices in general.

### FIELD

The present disclosure relates generally to electronic devices, and more particularly to methods and apparatus for configuring button assignment based on orientation of a device.

### BACKGROUND

Currently, many electronic devices include displays which can be configured to orient a display based on an orientation of a device. This feature is popular for many devices. These devices typically include a button on the housing of the device. For example, some devices may include a home button. With rotation of the device, the location of the home button will change. The function of the home button on conventional devices will remain the same. As a result, users must change their behavior to operate a device. Because many devices utilize a physical button for the home feature, the devices do not allow for the function of the home button to be assigned to another button. Similarly for devices that include a plurality of physical buttons, or soft buttons for that matter, these devices are not configured to allow for functions to be assigned based on orientation. There exists a desire for a solution that overcomes one or more of the aforementioned drawbacks.

### BRIEF SUMMARY OF THE EMBODIMENTS

Disclosed and claimed herein are methods and apparatus for orientation sensitive configuration of a device. In one embodiment, a method includes detecting a change in orientation of a device, configuring a display of the device based on the change in orientation, and assigning operation of one or more buttons of the device based on the change in orientation, wherein a button of the device is assigned one or more functions not previously assigned to the button.

In another embodiment, a device is provided to include a display, one or more buttons, and a processor, wherein the processor is coupled to the display and one or more buttons. The processor is configured to detect a change in orientation of a device, configure a display of the device based on the change in orientation, and assign operation of one or more buttons of the device based on the change in orientation, wherein a button of the device is assigned one or more functions not previously assigned to the button. The device can relate to one of a portable electronic device, media player, eReader, personal communication device, handheld computing device, imaging device, tablet computing device, imaging device, gaming device, remote control, and computing device in general.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIGS. 1A-1B depict graphical representations of a device according to one or more embodiments;

FIG. 2 depicts a process for configuring operation of a device according to one or more embodiments;

FIG. 3 depicts a simplified block diagram of a device according to one embodiment;

FIG. 4 depicts a graphical representation of button assignments for a device according to one or more embodiments;

FIG. 5 depicts a graphical representation of a device and assignment states according to one or more embodiments;

FIG. 6 depicts a graphical representation for orientation sensitive button assignment according to one or more additional embodiments;

FIG. 7 depicts a process for operation of a device according to one or more embodiments;

FIG. 8 depicts a graphical representation of orientation ranges according to one or more embodiments; and

FIGS. 9A-9B depict graphical representations of a device according to one or more embodiments.

### DETAILED DESCRIPTION OF THE EXEMPLARY EMBODIMENTS

### Overview and Terminology

One aspect of the disclosure is directed to configuring electronic devices having displays. In particular embodiments, configuration of a device may be determined based on a change in orientation. In one embodiment, a device may be configured to provide a graphical display for a user interface of one or more applications. The device may further be configured to control display based on orientation of the device. Moreover, the device may configure the operation of one or more buttons of the device based on a detected orientation. In one embodiment, operation of buttons of the device may be assigned based on orientation or changes in orientation of the device. It should also be appreciated that buttons of the device may relate to physical or soft buttons.

Another embodiment of the invention relates to a process for orientation sensitive configuration. The process may include detecting a change in orientation of the device, configuring a display format, and assigning operation of one or more buttons. Based on detection of displacement and/or rotation of the device, the process may further include configuring operation of the device based on a change in orientation.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

### Exemplary Embodiments

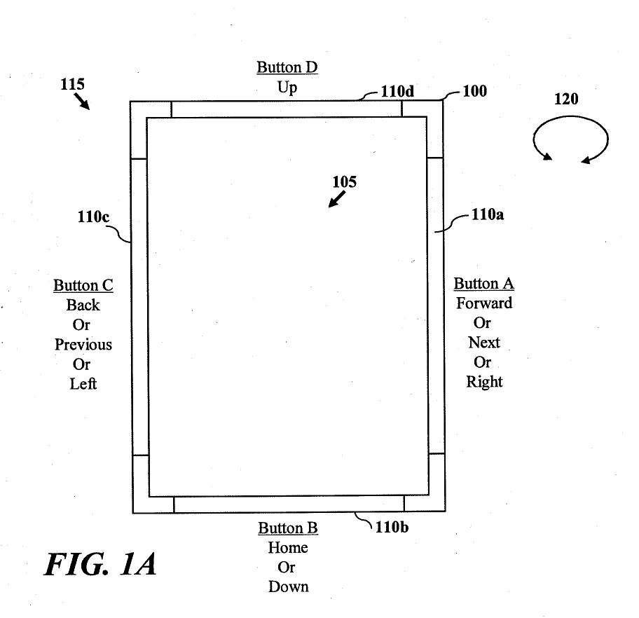

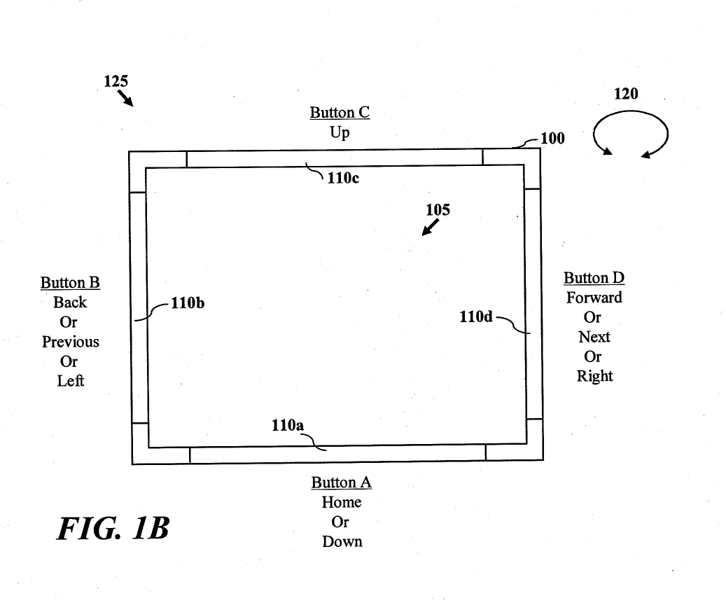

Referring now to the figures, FIGS. 1A-1B depict graphical representations of a device according to one or more embodiments. Referring first to FIG. 1A, a graphical representation is depicted of device 100. Device 100 includes display 105 and a plurality of buttons depicted as 110a-110d. According to one embodiment, device 100 may configure operation of buttons 110a-110d based on a detected orientation or changes in orientation. Device 100 may include one or more sensors (not depicted in FIG. 1A) which may be configured to detect the orientation or changes in orientation.

In FIG. 1A, device 100 is depicted in a portrait orientation identified as 115. The portrait orientation may relate to vertical orientation of device 100, wherein the height of the display is longer than the width of the display. Device 100 may be configured to detect changes in orientation, such as rotation of the device as depicted by 120. Rotation may relate to angular displacement of device 100 relative to a plane of the face (e.g., display area) of the device, as depicted by 120. As will be discussed in more detail below with reference to FIG. 3, device 100 may include single and/or multiple access sensors for detecting orientation and changes in orientation.

According to one embodiment, device 100 may assign operation of buttons 110a-110d based on a detected orientation, such as the portrait orientation of FIG. 1A. As depicted in FIG. 1A, button 110a (“Button A” in FIG. 1A) relates to a right side, relative to a user view, of device 100 based on orientation 115. Similarly, button 110b (“Button B” in FIG. 1A) relates to the bottom portion, button 110c (“Button C” in FIG. 1A) relates to a left side portion, and button 110d (“Button D” in FIG. 1A) relates to a top portion of the device. Each of buttons 110a-110d may be assigned one or more functions. In addition, buttons 110a-110d may be integrated with a housing of device 100 and may include elements to allow for backlit display based on an assignment of the button.

FIG. 1A includes exemplary descriptions of button functions that may be assigned according to one or more embodiments. By way of example, when arranged in orientation 115, device 100 may recognize activations of button 110a as one or more of a forward, next or right command. Similarly, button 110c may be configured to provide one or more of a back, previous or left command. Button 110b may be configured to provide one or more of a home or down command. A home command may relate to accessing a home menu of an application executed by the device. Button 110d may be configured to provide an up command. In certain embodiments, buttons may be assigned for selection of a drop down menu. The commands identified with each button may be associated with operation of a user interface or graphical element display by device 100, such as a network browsing application, media application, document viewer, gaming application, and/or communication application (e.g., phone, email, text, messaging, etc.). It should be appreciated that functions that may be assigned to buttons are not limited to the functions identified in FIG. 1A. By way of example, a button, such as button 110d may be assigned for initiating display of a drop down menu when selected by a user. Similarly, functions assigned to buttons 110a-110d may be based on the number of activations and/or time period a button is activated. Activation of a button of device 100 repeatedly may indicate scrolling, advancing, etc. In certain embodiments, device 100 may only assign functions to a portion of the buttons based on a detected orientation.

Based on a change in orientation detected by device 100, the operation of one or more buttons may be reconfigured. Referring now to FIG. 1B, device 100 is depicted in a new orientation, orientation 125, relative to the orientation depicted in FIG. 1A. Orientation 125 relates to a landscape orientation of device 100. Device 100 may assign operation of one or more of buttons 110a-110d, based on the change in orientation. As depicted in FIG. 1B, device 100 may assign operation of button 110a (Button A) as a home or down button based on button 110a relating to the bottom portion of device 100 relative to user view. Buttons 110b (Button B) and 110d (Button D) may relate to left and right buttons respectively. Button 110c (Button C) may relate to the top button. According to one embodiment, a button may be assigned one or more functions not previously assigned to the button. In that fashion, a button that was previously assigned functions of the bottom is assigned functions associated with its current position. In that fashion, a user may advantageously activate buttons of device 100 regardless of device orientation. In addition, functions of the orientation in FIG. 1A may all remain for the orientation of FIG. 1B.

In one embodiment, reconfiguring operation of one or more of buttons 110a-110d may be based on detection of a change in orientation of device 100 which approaches, or is substantially similar to orientation 125. In certain embodiments, rotation greater than ±15° of angular position relative to orientation 125 may not trigger a configuration change. According to another embodiment, detection of a change in orientation may be based on a particular device. For example, for smaller handheld devices, the relative range of orientations that may correspond to a landscape orientation may be greater relative to the for range larger devices, such as a tablet computing device. In yet another embodiment, device 100 may be configured to have a greater range of angular offset for setting a portrait arrangement as depicted in FIG. 1A relative to orientations which may be employed for a landscape arrangement. By way of example, the device may favor displaying a portrait arrangement in some embodiments.

Although FIGS. 1A-1B are described above with reference to a portrait or landscape orientation, it should be appreciated that the principles of the disclosure may apply to one or more other configurations. For example, when a display of device 100 relates to a square, or other shaped display, device 100 may detect changes in orientation, such as particular angles of rotation for assigning buttons. Such a feature may be advantageous for particular input devices, such as gaming devices.

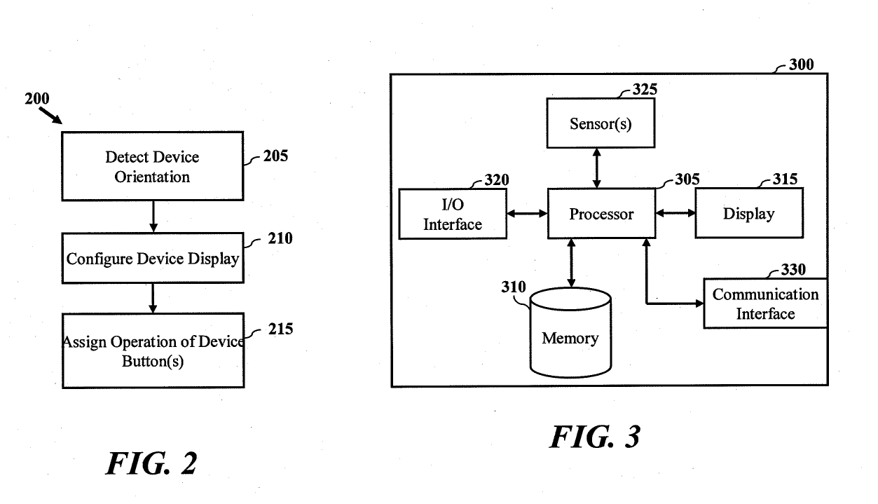

Referring now to FIG. 2, a process is depicted for configuring operation of a device according to one or more embodiments. In particular, process 200 may be employed for orientation sensitive button assignment of the device of FIGS. 1A-1B. Process 200 may similarly be employed for one or more of the devices described herein. Process 200 may be employed by computing devices including but not limited to portable electronic devices, media players, personal communication devices, tablet computers, imaging devices, eReader devices, gaming systems, etc.

Process 200 may be initiated by detecting a change in orientation of a device (e.g., device 100) at block 205. Detecting a change in orientation (e.g., change in orientation 120) may include determining whether the device is positioned relative to a portrait or landscape orientation, and may further include determining which portion of the device relates to the bottom (e.g., lower portion of the device). Detecting a change in orientation of the device at block 205 may include detecting a change in orientation exceeding a predetermined amount for a predetermined period of time. In an exemplary embodiment, an angular displacement of ±45° for a period of 1-2 seconds. It should be appreciated that other values may be employed.

Process 200 may then configure the display format of a display (e.g., display 105) at block 210 based on the detected orientation. Configuring the display of the device may relate to arranging a display orientation of an application or user interface for display by the device. For example, a graphical representation displayed by the device may be oriented relative to a user view. The display may similarly be oriented relative to a button of the device, such as a button determined to be the bottom button.

At block 215, the device may assign functions to one or more buttons based on the change in orientation. Functions assigned at block 215 may be for soft and/or physical buttons of the device. By way of example, the device may assign the bottom button to function as a home button. The device may configure left and right buttons (e.g., buttons 110c and 110a, of FIG. 1A respectively) based on the detection of a portrait orientation. Assignment of the buttons at block 215 may include assigning a button one or more functions not previously assigned to the button. For example, a button associated with the bottom of the device, based on the change in orientation, may be assigned a home function. Additional functions that may be assigned include one or more of a directional function, navigating function, a home function and function associated with an application of the device. In addition, a button may be assigned an illumination state at block 215.

Referring now to FIG. 3, a simplified block diagram is depicted of a device according to one embodiment. Device 300 may relate to a portable or hand held device including a display. Device 300 may relate to one or more of a computing device, portable electronic devices, media players, personal communication devices, tablet computers, imaging devices, eReader devices, gaming systems, etc. In one embodiment, device 300 relates to the device of FIG. 1.

As depicted in FIG. 3, device 300 includes processor 305, memory 310, display 315, input/output (I/O) interface 320, one or more sensors, depicted as sensor(s) 325, and communication interface 330. Processor 305 may be configured to control operation of device 300 based on one or more computer executable instructions stored in memory 310. In one embodiment, processor 305 may be configured to execute one or more applications allowing for an orientation sensitive user interface. Memory 310 may relate to one of RAM and ROM memories and may be configured to store one or more files, and computer executable instructions for operation of device 300. Although depicted as a single memory unit, memory 310 may relate to one or more of internal device memory and removable memory.

Display 315 may be employed to display text, image and/or video data, and display one or more applications executed by processor 305. In certain embodiments, display 315 may relate to a touch screen display. I/O interface 320 may be employed to control operation of device 300. I/O interface 320 may include one or more buttons for user input, such as a such as a numerical keypad, volume control, menu controls, pointing device, track ball, mode selection buttons, and playback functionality (e.g., play, stop, pause, forward, reverse, slow motion, etc). Buttons of I/O interface 320 may include hard and soft buttons, wherein functionality of the soft buttons may be based on one or more applications running on device 300. Buttons (e.g., buttons 110a-110d) of user interface 320 may be configured based on orientation of device 300.

Device 300 may include one or more sensors configured to detect displacement or orientation. Sensor(s) 325 may relate to one or more single or multi-axis sensors configured to detect displacement in one or more dimensions. In certain embodiments, sensor(s) 325 may relate to a sensor configured to detect changes in orientation relative to a plane of the device display. Sensor(s) 325 may relate to three-axis sensors, such as three-axis magnetometers and three-axis accelerometers.

Communication interface 330 may be configured to allow for receiving and/or transmitting data relative to one or more devices. Communication interface 330 may be configured to allow for one or more devices to communicate with device 300 via wired or wireless communication (e.g., Bluetooth™, infrared, etc.). Communication interface 330 may include one or more ports for receiving data, including ports for removable memory. Communication interface 330 may be configured to allow for network based communications including but not limited to LAN, WAN, Wi-Fi, etc. In one embodiment, communication interface 330 may be configured to access an electronic text stored by a server.

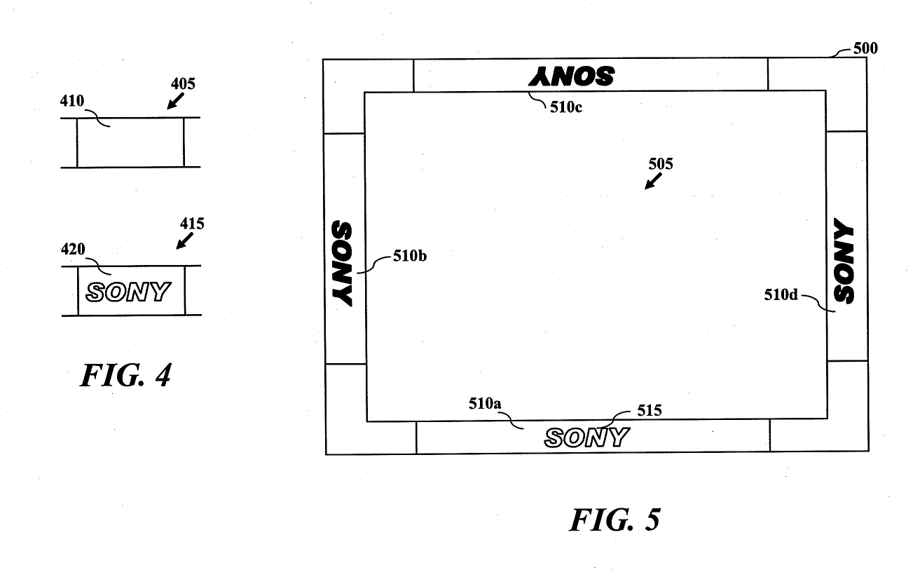

Referring now FIG. 4, a graphical representation is depicted of button assignment for a device (e.g., device 100 of FIG. 1A-1B). According to one embodiment, buttons of a device may include one or more regions that may be illuminated. Illumination may be based on the orientation of the device. Further, a button, or a portion of a button, such as a logo (e.g., “SONY” in FIG. 4) may be backlit based on an assignment. FIG. 4 depicts two configuration states which may be employed for a button of a device as described herein. Configuration state 405 relates to configuration of a button without illumination. As depicted, button 410 appears to be in an off state, wherein the button does not appear to be illuminated and the logo is not visible. In contrast, configuration state 425 relates to configuration of a button with illumination. Illumination may be provided by a lighting element (e.g., LED) of the device to provide a backlit display of the button. Button 420 allows for a user to view a button based on illumination of text associated with a logo or other identifier. As such, a device may be configured to control a configuration state to identify which state is illuminated. In certain embodiments, buttons may be backlit with different colors to indicate an assignment of a function.

Referring now to FIG. 5, a graphical representation of a device and assignment states are depicted according to one or more embodiments. Device 500 includes display 505 and may be configured to assign operation of buttons 510a-510d based on orientation of the device. Device 500 may relate to the device of FIGS. 1A-1B. According to one embodiment, device 500 may configure the appearance of buttons 510a-510d based on orientation. As depicted in FIG. 5, device 500 is arranged in a landscape orientation, wherein button 510a relates to the bottom button. Device 500 may assign button 510a with a configuration state identifying its configuration based on backlighting of the “SONY” logo depicted as 515. Configuration state 515 may differ from the configurations states of buttons 510b-510d. In that fashion, device 500 may provide an indication of a particular button regardless of the orientation of the device. Users may find the assignment states advantageous, as a user does not have to change operation of the device based on device orientation. For example, when home button functionality is assigned to the bottom button, button 510a in FIG. 5, the device may be configured to assign operation of a bottom button with a function expected by the user.

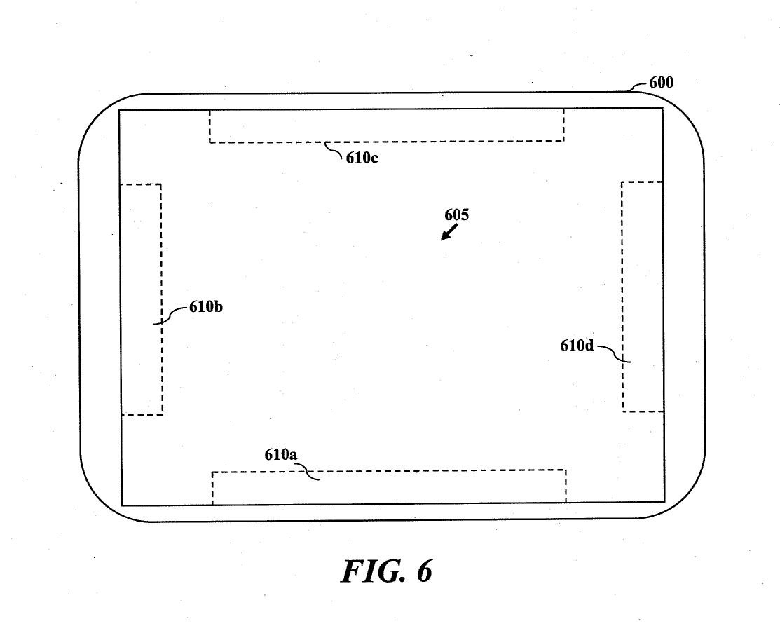

Referring now to FIG. 6, a graphical representation is depicted for orientation sensitive button assignment according to another embodiment. Device 600 includes display 605. Display 605 may relate to a touch sensitive display. According to one embodiment of the invention, regions of touch sensitive display 605 may be configured based on orientation of device 600. Display 605 of device 600 includes regions 610a-610b which may relate to portions of the display which include or do not include graphical elements to identify the button. In some embodiments, soft buttons 610a-610b may include display of an element to identify activation of the soft button. Similar to the discussion above with reference to the buttons of FIGS. 1A-1B, device 600 may configure regions of display 605 based on orientation of device 600.

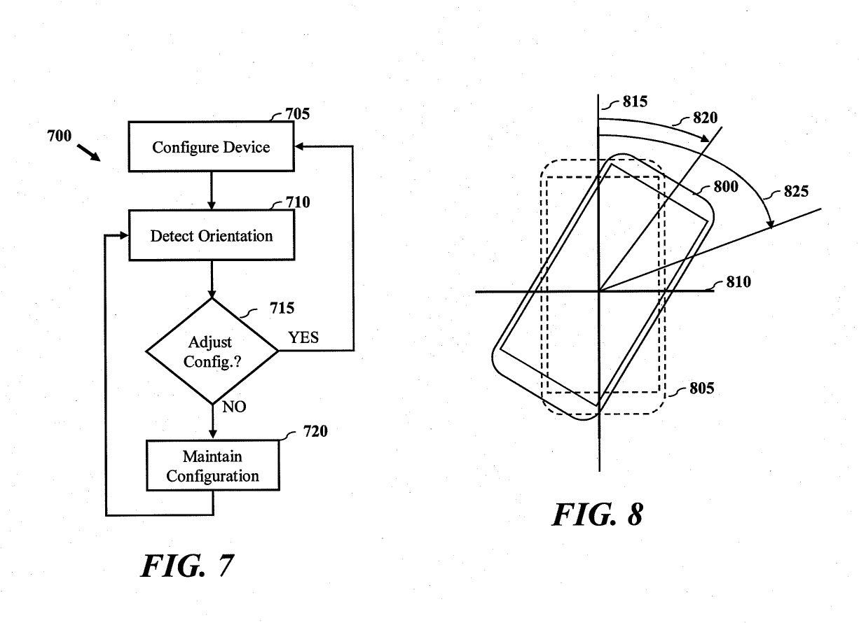

Referring now to FIG. 7, a process is depicted for operation of a device according to one or more embodiments. Process 700 may be employed by a device (e.g., device 100) to determine whether to adjust a configuration of the device. In one embodiment, the device may determine whether a change in orientation should result in a configuration change of the device. Process 700 may be initiated by configuring the device at block 705. For example, the device may arrange the display and/or assignment of one or more buttons of the device. During use of the device, and in particular when the device is handheld, orientation of the device may change. However, when a user is operating the device it may not always be desired to change the display. For example, when the change in orientation relates to a small amount, the configuration of the device should not be changed.

At block 710, the device may detect a change in orientation. Based on the detected change in orientation, the device may determine whether to adjust the configuration at decision block 715. When the change in orientation exceeds a predetermined amount (e.g., “YES” path out of decision block 715) the device will configure the display and/or one or more buttons at block 705. When the change in orientation does not exceed a predetermined amount (e.g., “NO” path out of decision block 715) the device will maintain the configuration at block 720.

FIG. 8 depicts a graphical representation of orientation ranges that may be employed for determining whether to update a configuration of a device. Device 800 is depicted in a state with an orientation 820 that differs from the orientation identified as 805. Orientation 805 may relate to an orientation for display in a portrait format. However, use or motion detected by the device 800 relative to a plane as depicted by axis 810 and axis 815 may be a basis for changing a device configuration. In one embodiment, the device may maintain the current configuration, such as a portrait orientation until changes in orientation exceed a predetermined value as depicted by 825. When the orientation of device 805 exceeds the angle of rotation as depicted by 825, the device may be configured to change the display. In certain embodiments, rotation within ±15° of axis 810 may relate to a landscape configuration.

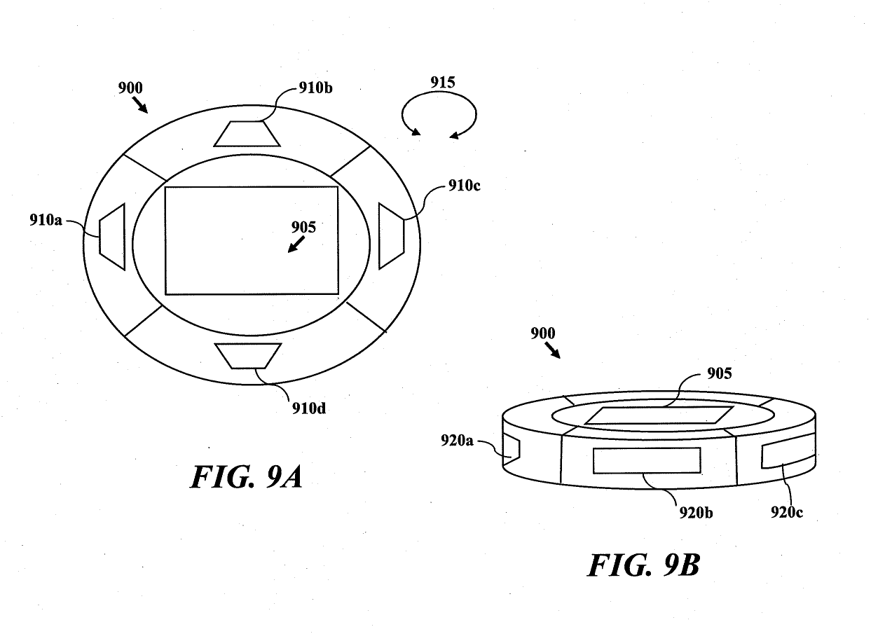

According to another embodiment, the principles of one or more embodiments described herein may be applied to a plurality of device shapes. For example, although the device of FIGS. 1A-1B are depicted as being rectangular, it should be appreciated that devices with a non-rectangular shape may be employed. Referring now to FIGS. 9A-9B graphical representations are depicted of devices according to one or more embodiments. Referring first to FIG. 9A, a graphical representation is depicted of device 900 having a round or substantially round housing or package. Similar to the device of FIGS. 1A-1B, device 900 may include display 905 and may be configured to assign operation of buttons 910a-910d based on a detected orientation or changes in orientation as depicted by 915. It should be appreciated that other device shapes may similarly be employed. Device 900, like the device of FIGS. 1A-1B may be configured to assign a button orientated at the top (button 910b is depicted as the top button for the orientation of FIG. 9A) to always function the same. Similarly, regardless of shape, a user can assume other buttons on the left, right, and bottom of the device will have the same functionality. By way of further example, regardless of shape when button 910d is in the bottom position, as depicted in FIG. 9A, or when button 910c is in the bottom position, the button associated with the bottom position will have the same function.

In FIG. 9B, a perspective view of device 900 is depicted including display 905. According to another embodiment, buttons of the device may be located on the side or lateral portion of a housing as depicted in FIG. 9B. As shown, buttons 920a-920c are located on a side portion of the housing. Buttons 920a-920c may be assigned functions similar to buttons 910a-910d above.

While this disclosure has been particularly shown and described with references to exemplary embodiments thereof, it will be understood by those skilled in the art that various changes in form and details may be made therein without departing from the scope of the embodiments encompassed by the appended claims.

What is claimed is:

1. A method for orientation sensitive configuration of a device, the method comprising the acts of:
detecting a change in orientation of a device;
configuring a display of the device based on the change in orientation; and
assigning operation of one or more buttons of the device based on the change in orientation, wherein a button of the device is assigned one or more functions not previously assigned to the button.

2. The method of claim 1, wherein the change in orientation relates to orientation of the device relative to one of a portrait and landscape configuration.

3. The method of claim 1, wherein configuring the display of the device relates to arranging a display orientation of the display relative to the button of the device assigned one or more functions.

4. The method of claim 1, wherein assigning operation of one or more buttons relates to setting functions of one or more physical buttons based on orientation.

5. The method of claim 4, wherein a button is assigned one or more of a directional function, navigating function, a home function and function associated with an application of the device.

6. The method of claim 4, wherein assigning operation of one or more buttons relates to setting an illumination state of a button.

7. The method of claim 1, wherein assigning operation of one or more buttons relates to setting one or more functions for one or more soft buttons of the device based on orientation, wherein each soft button is associated with a region of the display.

8. The method of claim 1, wherein detecting a change in orientation of the device relates to detecting a change in orientation exceeding a predetermined amount for a predetermined period of time.

9. A computer program product stored on computer readable medium including computer executable code for orientation sensitive configuration of a device, the computer program product comprising:
computer readable code to detect a change in orientation of a device;
computer readable code to configure a display of the device based on the change in orientation; and
computer readable code to assign operation of one or more buttons of the device based on the change in orientation, wherein a button of the device is assigned one or more functions not previously assigned to the button.

10. The computer program product of claim 9, wherein the change in orientation relates to orientation of the device relative to one of a portrait and landscape configuration.

11. The computer program product of claim 9, wherein configuring the display of the device relates to arranging a display orientation of the display relative to the button of the device assigned one or more functions.

12. The computer program product of claim 9, wherein assigning operation of one or more buttons relates to setting functions of one or more physical buttons based on orientation.

13. The computer program product of claim 12, wherein a button is assigned one or more of a directional function, navigating function, a home function and function associated with an application of the device.

14. The computer program product of claim 12, wherein assigning operation of one or more buttons relates to setting an illumination state of a button.

15. The computer program product of claim 9, wherein assigning operation of one or more buttons relates to setting one or more functions for one or more soft buttons of the device based on orientation, wherein each soft button is associated with a region of the display.

16. The computer program product of claim 9, wherein the change in orientation of the device relates to detecting a change in orientation exceeding a predetermined angular amount relative to a plane of the device for a predetermined period of time.

17. A device comprising:
a display;
one or more buttons; and
a processor coupled to the display and one or more buttons, the processor configured to
detect a change in orientation of a device;
configure a display of the device based on the change in orientation; and
assign operation of one or more buttons of the device based on the change in orientation, wherein a button of the device is assigned one or more functions not previously assigned to the button.

18. The device of claim 17, wherein the device relates to one or more of a portable electronic device, media player, eReader, personal communication device, handheld computing device, imaging device, tablet computing device, imaging device, gaming device and computing devices in general.

19. The device of claim 17, wherein assigning operation of one or more buttons relates to setting functions of one or more physical buttons based on orientation.

20. The device of claim 19, wherein a button is assigned one or more of a directional function, navigating function, a home function and function associated with an application of the device.

21. The device of claim 19, wherein assigning operation of one or more buttons relates to setting an illumination state of a button.

22. The device of claim 17, wherein assigning operation of one or more buttons relates to setting one or more functions for one or more soft buttons of the device based on orientation, wherein each soft button is associated with a region of the display.
